(19) United States
(12) Patent Application Publication
(10) Pub. No.: US 2020/0316490 A1
(43) Pub. Date: Oct. 8, 2020

(54) METHOD, SYSTEM, AND APPARATUS FOR INHIBITING DECOMPOSITION OF HYDROGEN PEROXIDE IN GAS DELIVERY SYSTEMS

(71) Applicant: RASIRC, Inc., San Diego, CA (US)

(72) Inventors: Christopher Ramos, Bonita, CA (US); Edward Heinlein, San Diego, CA (US); Sean Webb, San Diego, CA (US); Jeffrey Spiegelman, San Diego, CA (US); Russell Holmes, San Diego, CA (US); Daniel Alvarez, Oceanside, CA (US)

(21) Appl. No.: 16/464,160

(22) PCT Filed: Nov. 16, 2017
(86) PCT No.: PCT/US2017/061950

§ 371 Date: May 24, 2019

Related U.S. Application Data
(60) Provisional application No. 62/428,808, filed on Dec. 1, 2016.
(60) Provisional application No. 62/466,020, filed on Mar. 2, 2017.

(51) Int. Cl. B01B 1/00; B01D 19/00; B01D 69/02; C01B 15/013

(52) U.S. Cl. CPC B01B 1/005; B01D 19/0031; B01D 2325/42; C01B 15/013; B01D 69/02

(57) ABSTRACT

Provided herein are methods, systems, and apparatus for inhibiting decomposition of hydrogen peroxide gas through use of surface modification of production and delivery components.

### CROSS REFERENCE TO RELATED APPLICATION(S)

This application claims the benefit of priority under 35 U.S.C. § 119(e) of U.S. Ser. No. 62/428,808, filed Dec. 1, 2016, and of U.S. Ser. No. 62/466,020, filed Mar. 2, 2017, the entire content of each of which is incorporated herein by reference.

### BACKGROUND OF THE INVENTION

### Field of the Invention

The invention relates generally to hydrogen peroxide and more specifically to methods, systems, and devices for the vapor phase delivery of a high purity hydrogen peroxide gas stream for use in micro-electronics and other critical process applications.

### Background Information

Various process gases may be used in the manufacturing and processing of micro-electronics. In addition, a variety of chemicals may be used in other environments demanding high purity gases, e.g., critical processes, including without limitation microelectronics applications, wafer cleaning, wafer bonding, photoresist stripping, silicon oxidation, surface passivation, photolithography mask cleaning, atomic layer deposition, chemical vapor deposition, flat panel displays, disinfection of surfaces contaminated with bacteria, viruses and other biological agents, industrial parts cleaning, pharmaceutical manufacturing, production of nano-materials, power generation and control devices, fuel cells, power transmission devices, and other applications in which process control and purity are critical considerations. In those processes, it is necessary to deliver specific amounts of certain process gases under controlled operating conditions, e.g., temperature, pressure, and flow rate.

For a variety of reasons, gas phase delivery of process chemicals is preferred to liquid phase delivery. For applications requiring low mass flow for process chemicals, liquid delivery of process chemicals is not accurate or clean enough. Gaseous delivery would be desired from a standpoint of ease of delivery, accuracy and purity. Gas flow devices are better attuned to precise control than liquid delivery devices. Additionally, micro-electronics applications and other critical processes typically have extensive gas handling systems that make gaseous delivery considerably easier than liquid delivery. One approach is to vaporize the process chemical component directly at or near the point of use. Vaporizing liquids provides a process that leaves heavy contaminants behind, thus purifying the process chemical. However, for safety, handling, stability, and/or purity reasons, many process gases are not amenable to direct vaporization.

There are numerous process gases used in micro-electronics applications and other critical processes. Ozone is a gas that is typically used to clean the surface of semiconductors (e.g., photoresist stripping) and as an oxidizing agent (e.g., forming oxide or hydroxide layers). One advantage of using ozone gas in micro-electronics applications and other critical processes, as opposed to prior liquid-based approaches, is that gases are able to access high aspect ratio features on a surface. For example, according to the International Technology Roadmap for Semiconductors (ITRS), current semiconductor processes should be compatible with a half-pitch as small as 20-22 nm. The next technology node for semiconductors is expected to have a half-pitch of 14-16 nm, and the ITRS calls for <10 nm half-pitch in the near future. At these dimensions, liquid-based chemical processing is not feasible because the surface tension of the process liquid prevents it from accessing the bottom of deep holes or channels and the corners of high aspect ratio features. Therefore, ozone gas has been used in some instances to overcome certain limitations of liquid-based processes because gases do not suffer from the same surface tension limitations. Plasma-based processes have also been employed to overcome certain limitations of liquid-based processes. However, ozone- and plasma-based processes present their own set of limitations, including, inter alia, cost of operation, insufficient process controls, undesired side reactions, and inefficient cleaning.

More recently, hydrogen peroxide has been explored as a replacement for ozone in certain applications. However, hydrogen peroxide has been of limited utility because highly concentrated hydrogen peroxide solutions present serious safety and handling concerns and obtaining high concentrations of hydrogen peroxide in the gas phase has not been possible using existing technology. Hydrogen peroxide is typically available as an aqueous solution. In addition, because hydrogen peroxide has a relatively low vapor pressure (boiling point is approximately 150° C.), available methods and devices for delivering hydrogen peroxide generally do not provide hydrogen peroxide containing gas streams with a sufficient concentration of hydrogen peroxide. For vapor pressure and vapor composition studies of various hydrogen peroxide solutions, see, e.g., Hydrogen Peroxide, Schumb, et al., Reinhold Publishing Corporation, 1955, New York, available at hdl.handle.net/2027/mdp.39015003708784. Moreover, studies show that delivery into vacuum leads to even lower concentrations of hydrogen peroxide (see, e.g., Hydrogen Peroxide, Schumb, pp. 228-229). The vapor composition of a 30 H₂O₂ aqueous solution delivered using a vacuum at 30 mm Hg is predicted to yield approximately half as much hydrogen peroxide as would be expected for the same solution delivered at atmospheric pressure.

Gas phase delivery of low volatility compounds presents a particularly unique set of problems. One approach is to provide a multi-component liquid source wherein the process chemical is mixed with a more volatile solvent, such as water or an organic solvent (e.g., isopropanol). However, when a multi-component solution is the liquid source to be delivered (e.g., hydrogen peroxide and water), Raoult's Law for multi-component solutions becomes relevant. According to Raoult's Law, for an idealized two-component solution, the vapor pressure of the solution is equal to the weighted sum of the vapor pressures for a pure solution of each component, where the weights are the mole fractions of each component:

Pₜₒₜ=P_{aXa}+P_{bXb}

In the above equation, Ptot is the total vapor pressure of the two-component solution, Pa is the vapor pressure of a pure solution of component A, xa is the mole fraction of component A in the two-component solution, Pb is the vapor pressure of a pure solution of component B, and x_{b} is the mole fraction of component B in the two-component solution. Therefore, the relative mole fraction of each component is different in the liquid phase than it is in the vapor phase above the liquid. Specifically, the more volatile component (i.e., the component with the higher vapor pressure) has a higher relative mole fraction in the gas phase than it has in the liquid phase. In addition, because the gas phase of a typical gas delivery device, such as a bubbler, is continuously being swept away by a carrier gas, the composition of the two-component liquid solution, and hence the gaseous head space above the liquid, is dynamic.

Thus, according to Raoult's Law, if a vacuum is pulled on the head space of a multi-component liquid solution or if a traditional bubbler or vaporizer is used to deliver the solution in the gas phase, the more volatile component of the liquid solution will be preferentially removed from the solution as compared to the less volatile component. This limits the concentration of the less volatile component that can be delivered in the gas phase. For instance, if a carrier gas is bubbled through a 30% hydrogen peroxide/water solution, only about 295 ppm of hydrogen peroxide will be delivered, the remainder being all water vapor (about 20,000 ppm) and the carrier gas.

The differential delivery rate that results when a multi-component liquid solution is used as the source of process gases make repeatable process control challenging. It is difficult to write process recipes around continuously changing mixtures. In addition, controls for measuring a continuously changing ratio of the components of the liquid source are not readily available, and if available, they are costly and difficult to integrate into the process. In addition, certain solutions become hazardous if the relative ratio of the components of the liquid source changes. For example, hydrogen peroxide in water becomes explosive at concentrations over about 75%; and thus, delivering hydrogen peroxide by bubbling a dry gas through an aqueous hydrogen peroxide solution, or evacuating the head space above such solution, can take a safe solution (e.g., 30% H₂O₂/H₂O) and convert it to a hazardous material that is over 75% hydrogen peroxide. Therefore, currently available delivery devices and methods are insufficient for consistently, precisely, and safely delivering controlled quantities of process gases in many micro-electronics applications and other critical processes.

Therefore, a technique is needed to overcome these limitations and, specifically, to allow vapor phase delivery of a sufficiently high concentration of high purity hydrogen peroxide to be used in a critical process application, such as microelectronics manufacturing.

### SUMMARY OF THE INVENTION

The present invention is based on the finding that decomposition of hydrogen peroxide gas at high temperatures is minimized through use of one or more process components that are coated with a material composition of Silicon (Si), methyl groups, and sylinols. By replacing at least one component within the system and/or device for delivering the hydrogen peroxide gas that is typically plastic with the coated materials provided herein, user safety is increased through use of materials configured to handle higher temperatures and pressures without decomposing the hydrogen peroxide. Accordingly, in one aspect, the present invention provides a method that includes providing in an enclosed chamber a hydrogen peroxide solution having a vapor phase that is adjacent to the hydrogen peroxide solution; contacting a carrier gas or vacuum with the vapor phase for form a gas stream; and delivering the gas stream comprising at least 1000 parts per million (ppm) hydrogen peroxide to a critical process, application or storage vessel, wherein at least one component selected from the group consisting of a surface of the chamber, a tube in fluid communication with the chamber, or a surface of the storage vessel has previously undergone surface modification. In various embodiments, the hydrogen peroxide solution is aqueous or non-aqueous. In various embodiments, the hydrogen peroxide solution has a vapor phase separated from the hydrogen peroxide solution by a membrane such as an ion exchange membrane. In various embodiments, the at least one component is formed from a material selected from the group consisting of stainless steel, quartz, nickel, aluminum, hastelloy, and monel, and any one or more contact surfaces between the at least one component and the gas stream is treated with a surface-coat selected from the group consisting of silicon, silicone, SiO₂, and combinations thereof (e.g., SILCOLLOY® (SilcoTek Corporation, Bellefonte, Pa.)). In various embodiments, the at least one component is heated to between 30° C. and about 300° C., such as between 80° C. and about 200° C. The pressure within the at least one component may be between 0.75 Torr and 760 Torr. In various embodiments, the method may further include adding a dilute aqueous hydrogen peroxide solution to the hydrogen peroxide solution within the enclosed chamber to maintain the concentration of the aqueous hydrogen peroxide solution in the chamber.

In another aspect, the present invention provides a chemical delivery system. The system includes a hydrogen peroxide solution provided in an enclosed chamber, wherein the hydrogen peroxide solution has a vapor phase separated from or adjacent to the hydrogen peroxide solution; a carrier gas or vacuum in fluid contact with the vapor phase, thereby forming a gas stream within the chamber; and an apparatus in fluid communication with the chamber and configured for delivering a gas stream comprising at least 1000 ppm hydrogen peroxide to a critical process, application, or storage vessel, wherein any one or more contact surfaces between the apparatus and the gas stream is treated with a surface-coat selected from the group consisting of silicon, silicon, silicone, SiO₂, and combinations thereof. In various embodiments, the hydrogen peroxide solution is aqueous or non-aqueous. In various embodiments, at least one of the chamber, apparatus or storage vessel is formed from a material selected from the group consisting of stainless steel, quartz, nickel, aluminum, hastelloy, and monel.

In another aspect, the present invention provides a hydrogen peroxide delivery device. The device includes a housing having within it at least one membrane; a hydrogen peroxide liquid solution contained within the housing; and a head space contained within the housing and separated from the hydrogen peroxide solution by the membrane, wherein the housing is configured to allow a carrier gas to flow through the head space to produce a gas stream comprising at least 1000 ppm hydrogen peroxide to a critical process, application or storage vessel, and wherein any one or more contact surfaces between the housing and the gas stream is formed from a material selected from the group consisting of stainless steel, quartz, nickel, aluminum, hastelloy, and monel. In various embodiments, any component formed from stainless steel, quartz, nickel, aluminum, hastelloy, or monel is treated with a surface-coat selected from the group consisting of silicon, silicon, silicone, SiO₂, and combinations thereof. In various embodiments, the hydrogen peroxide solution is aqueous or non-aqueous. In various embodiments, hydrogen peroxide delivery device also includes a container in fluid communication with the housing and configured to add a dilute aqueous hydrogen peroxide solution to the hydrogen peroxide solution within the housing.

In another aspect, the present invention provides a method of delivering dilute vapor comprising hydrogen peroxide to a critical process, application or storage vessel. The method includes providing a concentrated aqueous hydrogen peroxide solution in a boiler having a head space; heating the concentrated aqueous hydrogen peroxide solution to produce a dilute vapor comprising hydrogen peroxide within the head space of the boiler; adding a dilute aqueous hydrogen peroxide solution to the concentrated aqueous hydrogen peroxide solution within the boiler to maintain the concentration of the aqueous hydrogen peroxide solution in the boiler; and delivering the dilute vapor comprising hydrogen peroxide to a critical process, application or storage vessel, wherein at least one component selected from the group consisting of a surface of the chamber, a tube in fluid communication with the chamber, or a surface of the storage vessel has previously undergone surface modification. In various embodiments, the at least one component is formed from a material selected from the group consisting of stainless steel, quartz, nickel, aluminum, hastelloy, and monel, wherein any one or more contact surfaces between the component and the gas stream is treated with a surface-coat selected from the group consisting of silicon, silicone, SiO₂, and combinations thereof. In various embodiments, the at least one component is heated to between 30° C. and about 300° C., such as between 80° C. and about 200° C. The pressure within the at least one component may be between 0.75 Torr and 760 Torr.

In another aspect, the present invention provides a chemical delivery system. The system includes a concentrated aqueous hydrogen peroxide solution; a boiler having a head space and configured for boiling the concentrated aqueous hydrogen peroxide solution to produce a dilute vapor comprising hydrogen peroxide within the head space; and a manifold in fluid communication with the boiler and configured for adding a dilute aqueous hydrogen peroxide solution to the concentrated aqueous hydrogen peroxide solution within the boiler to maintain the concentration of the aqueous hydrogen peroxide solution in the boiler; wherein the manifold is further configured to deliver the dilute vapor comprising hydrogen peroxide to a critical process, application or storage vessel. At least one component selected from the group consisting of the boiler, the manifold, and a tube in fluid communication with boiler or manifold may be formed a material selected from the group consisting of stainless steel, quartz, nickel, aluminum, hastelloy, and monel, wherein any contact surface between the at least one component and the gas stream has previously undergone surface modification. In various embodiments, the surface modification is a surface-coat selected from the group consisting of silicon, silicone, SiO₂, and combinations thereof.

The devices provided herein may further comprise various components for containing and controlling the flow of the gases and liquids used therein. For example, the devices may further comprise mass flow controllers, valves, check valves, pressure gauges, regulators, rotameters, and pumps. The devices provided herein may further comprise various heaters, thermocouples, and temperature controllers to control the temperature of various components of the devices and steps of the methods. Such components may be made from a metal, such as stainless steel, and any contact surfaces with the hydrogen peroxide gas may be subjected to surface modification to minimize decomposition of the hydrogen peroxide gas. In preferred embodiments, any one or more contact surfaces are treated with a surface-coat selected from the group consisting of silicon, silicone, SiO₂, and combinations thereof.

### BRIEF DESCRIPTION OF THE DRAWINGS

FIG. 1 is a pictorial diagram showing an exemplary P&ID.

FIG. 2 is a graphical diagram showing Brute Peroxide Decomposition results with 3-meter conditioned SS, Re-conditioned stainless steel (SS), fluorinated ethylene propylene (FEP) coated SS, and perfluoroalkoxy (PFA) tubing under vacuum pressure.

FIG. 3 is a pictorial diagram showing an exemplary P&ID.

FIG. 4 is a graphical diagram showing Brute Peroxide Decomposition results with 3-meter conditioned SS, Re-conditioned SS, FEP coated SS, and PFA under vacuum pressure.

FIG. 5 is a graphical diagram showing Brute Peroxide Decomposition with 3-meter conditioned SS, Re-conditioned SS, and FEP coated SS models under vacuum pressure.

### DETAILED DESCRIPTION OF THE INVENTION

The present invention is based on the finding that decomposition of hydrogen peroxide gas at high temperatures is minimized through use of one or more process components that are coated with a material composition of Silicon (Si), methyl groups, and sylinols. As described in detail below, hydrogen peroxide gas must be heated to prevent condensation thereof. While stainless steel tubing is preferred in many process gas delivery systems, heated stainless steel tubing leads to rapid decomposition of the H₂O₂ gas, which renders the gas unusable in various processes. Additionally, while PFA and other plastic tubing is inert for H₂O₂ gas, it does not meet safety standards for toxic gases such as H₂O₂. Accordingly, the present invention is directed to integrating coated components formed from stainless steel, quartz, nickel, aluminum, hastelloy, or monel into the systems and methods of producing, delivering, and/or storing high purity hydrogen peroxide gas. Also contemplated is surface-coating of any contact area between the source and use/storage point. For example, components such as, but not limited to, tubing, vessels, chambers, fittings, valves, filter housings, gas pressure regulators, flow meters, heat exchangers, shower heads, gas diffusers, and pressure sensors may be coated to prevent decomposition of the hydrogen peroxide gas used in any passivation or oxidation process for semiconductor, microelectronics, displays, and LEDs, as well as for sterilization including food service, medical, hospital, and transportation.

Before the present systems and methods are described, it is to be understood that this invention is not limited to particular system, methods, devices, and experimental conditions described, as such methods and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”, “an”, and “the” include plural references unless the context clearly dictates otherwise. Thus, for example, references to “the method” includes one or more methods, and/or steps of the type described herein which will become apparent to those persons skilled in the art upon reading this disclosure and so forth.

The term “comprising,” which is used interchangeably with “including,” “containing,” or “characterized by,” is inclusive or open-ended language and does not exclude additional, unrecited elements or method steps. The phrase “consisting of” excludes any element, step, or ingredient not specified in the claim. The phrase “consisting essentially of” limits the scope of a claim to the specified materials or steps and those that do not materially affect the basic and novel characteristics of the claimed invention. The present disclosure contemplates embodiments of the invention compositions and methods corresponding to the scope of each of these phrases. Thus, a composition or method comprising recited elements or steps contemplates particular embodiments in which the composition or method consists essentially of or consists of those elements or steps.

Unless defined otherwise, all technical and scientific terms used herein have the same meaning as commonly understood by one of ordinary skill in the art to which this invention belongs. Although any methods and materials similar or equivalent to those described herein can be used in the practice or testing of the invention, the preferred methods and materials are now described.

The term “surface modification” refers to treatment of one or more surfaces of a component used in a gas generation, gas delivery, or gas storage system, where the coating is inert to process gases at high temperature. Exemplary surface modification techniques are disclosed in U.S. Pat. No. 7,867,627, incorporated herein by reference, which include, for example, a chemical vapor deposition process such as exposure to SiH₄ gas under high temperature, followed by ethane and air exposure at high temperatures, which results in a thin (e.g., approximately 2000 nm in thickness) uniform coating on exposed surfaces. In various embodiments, the surface-coat is selected from the group consisting of silicon, silicone, SiO₂, and combinations thereof. Such surface modification coatings are provided by SilcoTek (Bellefonte, Pa.) under the tradenames SILCOLLOY®, DURSAN®, SILCONERT®, SILCOKLEAN®, SILCOGUARD® AND DURSOX®.

The term “process gas” as used herein is a broad term, and is to be given its ordinary and customary meaning to a person of ordinary skill in the art (and is not to be limited to a special or customized meaning), and refers without limitation to a gas that is used in an application or process, e.g., a step in the manufacturing or processing of micro-electronics and in other critical processes. Exemplary process gases are inorganic acids, organic acids, inorganic bases, organic bases, and inorganic and organic solvents. A preferred process gas is hydrogen peroxide.

The term “reactive process gas” as used herein is a broad term, and is to be given its ordinary and customary meaning to a person of ordinary skill in the art (and is not to be limited to a special or customized meaning), and refers without limitation to a process gas that chemically reacts in the particular application or process in which the gas is employed, e.g., by reacting with a surface, a liquid process chemical, or another process gas.

The term “non-reactive process gas” as used herein is a broad term, and is to be given its ordinary and customary meaning to a person of ordinary skill in the art (and is not to be limited to a special or customized meaning), and refers without limitation to a process gas that does not chemically react in the particular application or process in which the gas is employed, but the properties of the “non-reactive process gas” provide it with utility in the particular application or process.

The term “carrier gas” as used herein is a broad term, and is to be given its ordinary and customary meaning to a person of ordinary skill in the art (and is not to be limited to a special or customized meaning), and refers without limitation to a gas that is used to carry another gas through a process train, which is typically a train of piping. Exemplary carrier gases are nitrogen, argon, hydrogen, oxygen, CO₂, clean dry air, helium, or other gases that are stable at room temperature and atmospheric pressure.

The term “head space” as used herein is a broad term, and is to be given its ordinary and customary meaning to a person of ordinary skill in the art (and is not to be limited to a special or customized meaning), and refers without limitation to an enclosed space configured to hold a volume of gas in fluid contact with a source solution (e.g., a hydrogen peroxide solution) that provides at least a portion of the gas contained in the head space. There may be a permeable or selectively permeable barrier separating the head space that is optionally in direct contact with the hydrogen peroxide solution. In those embodiments where the membrane is not in direct contact with the hydrogen peroxide solution, more than one head space may exist, i.e. a first head space directly above the source solution that contains the vapor phase of the solution and a second head space separated from the first head space by a membrane that only contains the components from the first space that can permeate across the membrane, e.g., hydrogen peroxide. In those embodiments with a hydrogen peroxide solution and a head space separated by a substantially gas-impermeable membrane, the head space may be located above, below, or on any side of the hydrogen peroxide solution, or the head space may surround or be surrounded by the hydrogen peroxide solution. For example, the head space may be the space inside a substantially gas-impermeable tube running through the hydrogen peroxide solution or the hydrogen peroxide solution may be located inside a substantially gas-impermeable tube with the head space surrounding the outside of the tube.

The term “substantially gas-impermeable membrane” as used herein is a broad term, and is to be given its ordinary and customary meaning to a person of ordinary skill in the art (and is not to be limited to a special or customized meaning), and refers without limitation to a membrane that is relatively permeable to other components that may be present in a gaseous or liquid phase, e.g., hydrogen peroxide, but relatively impermeable to other gases such as, but not limited to, hydrogen, nitrogen, oxygen, carbon monoxide, carbon dioxide, hydrogen sulfide, hydrocarbons (e.g., ethylene), volatile acids and bases, refractory compounds, and volatile organic compounds.

The term “ion exchange membrane” as used herein is a broad term, and is to be given its ordinary and customary meaning to a person of ordinary skill in the art (and is not to be limited to a special or customized meaning), and refers without limitation to a membrane comprising chemical groups capable of combining with ions or exchanging with ions between the membrane and an external substance. Such chemical groups include, but are not limited to, sulfonic acid, carboxylic acid, sulfonamide, sulfonyl imide, phosphoric acid, phosphinic acid, arsenic groups, selenic groups, phenol groups, and salts thereof.

The term “non-aqueous solution” as used herein is a broad term, and is to be given its ordinary and customary meaning to a person of ordinary skill in the art (and is not to be limited to a special or customized meaning), and refers to a solution comprising two or more components containing less than 10% water.

The term “solvent” as used herein is a broad term, and is to be given its ordinary and customary meaning to a person of ordinary skill in the art (and is not to be limited to a special or customized meaning), and refers to any compound that produces a liquid when mixed with a solute, such as hydrogen peroxide, in the applicable ratio under the applicable operating conditions.

The advantageous hydrogen peroxide delivery provided by the present invention, and specifically, the methods, systems, and devices of certain embodiments described herein, may be obtained using a membrane contactor. In various embodiments, a non-porous membrane is employed to provide a barrier between the hydrogen peroxide solution and the head space that is in fluid contact with a carrier gas or vacuum. Preferably, hydrogen peroxide rapidly permeates across the membrane, while gases are excluded from permeating across the membrane into the solution. In some embodiments the membrane may be chemically treated with an acid, base, or salt to modify the properties of the membrane. In various embodiments, any non-membrane contact surfaces (for example, stainless steel tubing, process vessels, etc.) with the hydrogen peroxide gas may be subjected to surface modification to minimize decomposition of the hydrogen peroxide gas. In preferred embodiments, the contact surfaces are treated with a surface-coat selected from the group consisting of silicon, silicone, SiO₂, and combinations thereof. For example, the contact surface may be coated with SILCOLLOY® (SilcoTek Corporation, Bellefonte, Pa.).

In certain embodiments, the hydrogen peroxide is introduced into a carrier gas or vacuum through a substantially gas-impermeable ionic exchange membrane. Gas impermeability can be determined by the “leak rate.” The term “leak rate” as used herein is a broad term, and is to be given its ordinary and customary meaning to a person of ordinary skill in the art (and is not to be limited to a specialized or customized meaning), and refers without limitation to the volume of a particular gas that penetrates the membrane surface area per unit of time. For example, a substantially gas-impermeable membrane could have a low leak rate of gases (e.g., a carrier gas) other than a process gas (e.g., hydrogen peroxide), such as a leak rate of less than about 0.001 cm³/cm²/s under standard atmospheric temperature and pressure. Alternatively, a substantially gas-impermeable membrane can be identified by a ratio of the permeability of a process gas vapor compared to the permeability of other gases. Preferably, the substantially gas-impermeable membrane is more permeable to such process gases than to other gases by a ratio of at least 10,000:1, such as a ratio of at least about 20,000:1, 30,000:1, 40,000:1, 50,000:1, 60,000:1, 70,000:1, 80,000:1, 90,000:1 or a ratio of at least 100,000:1, 200,000:1, 300,000:1, 400,000:1, 500,000:1, 600,000:1, 700,000:1, 800,000:1, 900,000:1 or even a ratio of at least about 1,000,000:1. However, in other embodiments, other ratios that are less than 10,000:1 can be acceptable, for example 1.5:1, 2:1, 3:1, 4:1, 5:1, 6:1, 7:1, 8:1, 9:1, 10:1; 50:1, 100:1, 500:1, 1,000:1, or 5,000:1 or more.

In certain embodiments, the membrane is an ion exchange membrane, such as a polymer resin containing exchangeable ions. Preferably, the ion exchange membrane is a fluorine-containing polymer, e.g., polyvinylidenefluoride, polytetrafluoroethylene (PTFE), ethylene tetrafluoride-propylene hexafluoride copolymers (FEP), ethylene tetrafluoride-perfluoroalkoxyethylene copolymers (PFE), polychlorotrifluoroethylene (PCTFE), ethylene tetrafluorideethylene copolymers (ETFE), polyvinylidene fluoride, polyvinyl fluoride, vinylidene fluoride-trifluorinated ethylene chloride copolymers, vinylidene fluoride-propylene hexafluoride copolymers, vinylidene fluoridepropylene hexafluoride-ethylene tetrafluoride terpolymers, ethylene tetrafluoride-propylene rubber, and fluorinated thermoplastic elastomers. Alternatively, the resin comprises a composite or a mixture of polymers, or a mixture of polymers and other components, to provide a contiguous membrane material. In certain embodiments, the membrane material can comprise two or more layers. The different layers can have the same or different properties, e.g., chemical composition, porosity, permeability, thickness, and the like. In certain embodiments, it can also be desirable to employ a layer (e.g., a membrane) that provides support to the filtration membrane, or possesses some other desirable property.

The ion exchange membrane is preferably a perfluorinated ionomer comprising a copolymer of ethylene and a vinyl monomer containing an acid group or salts thereof. Exemplary perfluorinated ionomers include, but are not limited to, perfluorosulfonic acid/tetrafluoroethylene copolymers (“PFSA-TFE copolymer”) and perfluorocarboxylic acid/tetrafluoroethylene copolymer (“PFCA-TFE copolymer”). These membranes are commercially available under the tradenames NAFION® (E.I. du Pont de Nemours & Company), 3M Ionomer (Minnesota Mining and Manufacturing Co.), FLEMION® (Asashi Glass Company, Ltd.), and ACIPLEX® (Asashi Chemical Industry Company).

In preparing a hydrogen peroxide containing gas stream, a hydrogen peroxide solution can be passed through the membrane. The term “passing a hydrogen peroxide solution through a membrane” as used herein is a broad term, and is to be given its ordinary and customary meaning to a person of ordinary skill in the art (and is not to be limited to a special or customized meaning), and refers without limitation to contacting a first side of a membrane with the hydrogen peroxide solution, such that the hydrogen peroxide passes through the membrane, and obtaining a hydrogen peroxide containing gas stream on the opposite side of the membrane. The first and second sides can have the form of substantially flat, opposing planar areas, where the membrane is a sheet. Membranes can also be provided in tubular or cylindrical form where one surface forms the inner position of the tube and an opposing surface lies on the outer surface. The membrane can take any form, so long as the first surface and an opposing second surface sandwich a bulk of the membrane material. Depending on the processing conditions, nature of the hydrogen peroxide solution, volume of the hydrogen peroxide solution's vapor to be generated, and other factors, the properties of the membrane can be adjusted. Properties include, but are not limited to physical form (e.g., thickness, surface area, shape, length and width for sheet form, diameter if in fiber form), configuration (flat sheet(s), spiral or rolled sheet(s), folded or crimped sheet(s), fiber array(s)), fabrication method (e.g., extrusion, casting from solution), presence or absence of a support layer, presence or absence of an active layer (e.g., a porous prefilter to adsorb particles of a particular size, a reactive prefilter to remove impurities via chemical reaction or bonding), and the like. It is generally preferred that the membrane be from about 0.5 microns in thickness or less to 2000 microns in thickness or more, preferably from about 1, 5, 10, 25, 50, 100, 200, 300, 400, or 500 microns to about 600, 700, 800, 900, 1000, 1100, 1200, 1300, 1400, 1500, 1600, 1700, 1800, or 1900 microns. When thinner membranes are employed, it can be desirable to provide mechanical support to the membrane (e.g., by employing a supporting membrane, a screen or mesh, or other supporting structure), whereas thicker membranes may be suitable for use without a support. The surface area can be selected based on the mass of vapor to be produced.

Certain embodiments of the methods, systems, and devices provided herein, in which a carrier gas or vacuum can be used to deliver substantially water-free hydrogen peroxide, as set forth in commonly assigned U.S. Pat. No. 9,545,585, incorporated herein by reference).

According to certain embodiments of the present invention, a hydrogen peroxide delivery assembly (HPDA) is provided. An HPDA is a device for delivering hydrogen peroxide into a process gas stream, e.g., a carrier gas used in a critical process application, e.g., micro-electronics manufacturing or other critical process applications. An HPDA may also operate under vacuum conditions. An HPDA may have a variety of different configurations comprising at least one membrane and at least one vessel containing a non-aqueous hydrogen peroxide solution and a head space separated from the solution by membrane. As described herein, any contact surface of the at least one vessel that may come into contact with the hydrogen peroxide may be surface-coated to prevent and/or minimize vapor decomposition.

According to the various embodiments, the HPDA can be filled with a non-aqueous hydrogen peroxide containing solution, while maintaining a head space separated from the hydrogen peroxide containing solution by a membrane. Because the membrane is permeable to hydrogen peroxide and substantially impermeable to the other components of the solution, the head space will contain substantially pure hydrogen peroxide vapor in a carrier gas or vacuum, depending upon the operating conditions of the process. According to various embodiments, an HPDA can be constructed similarly to the devices described in commonly assigned U.S. Pat. No. 7,618,027, which is herein incorporated by reference. In various embodiments, at least one tube, component or contact surface of the delivery system is formed from a material selected from the group consisting of stainless steel, quartz, nickel, aluminum, hastelloy, and monel, and any contact surfaces (for example, tubing, process vessels, storage vessels, etc.) between the HPDA and the hydrogen peroxide gas may be subjected to surface modification to minimize decomposition of the hydrogen peroxide gas. In preferred embodiments, the contact surfaces are treated with a surface-coat selected from the group consisting of silicon, silicone, SiO₂, and combinations thereof. For example, the contact surfaces may be coated with SILCOLLOY® (SilcoTek Corporation, Bellefonte, Pa.).

By controlling the temperature of the hydrogen peroxide containing solution and, as applicable, the carrier gas or vacuum, particular hydrogen peroxide concentrations can be delivered. The selection of a particular hydrogen peroxide concentration will depend on the requirements of the application, process and/or storage requirements in which the hydrogen peroxide containing process gas will be used/stored. In certain embodiments, the hydrogen peroxide containing gas stream may be diluted by adding additional carrier gas. In certain embodiments, the hydrogen peroxide containing gas stream may be combined with other process gas streams prior to or at the time of delivering hydrogen peroxide to an application or process, or to a storage vessel. Alternatively or additionally, any residual solvent or stabilizers, or contaminants present in the hydrogen peroxide containing process gas may be removed in a purification (e.g., dehumidification) step using a purifier apparatus.

In another aspect, methods, systems and devices for delivering a high concentration hydrogen peroxide gas stream are provided. In various embodiments, a concentrated aqueous hydrogen peroxide solution is provided in a boiler having a head space, and the concentrated aqueous hydrogen peroxide solution is boiled to produce a dilute vapor comprising hydrogen peroxide within the head space of the boiler. Dilute aqueous hydrogen peroxide solution is added to the concentrated aqueous hydrogen peroxide solution within the boiler to maintain the concentration of the aqueous hydrogen peroxide solution in the boiler. As such, a consistent concentration of dilute vapor comprising hydrogen peroxide may be delivered to a critical process or application or to a storage vessel for future use. In various embodiments, any surfaces within the boiler, within the storage vessel, and between the boiler and the storage vessel or critical process or application, that may come into contact with the hydrogen peroxide vapor may be subjected to surface modification to minimize decomposition of the hydrogen peroxide vapor. In preferred embodiments, the contact surfaces are treated with a surface-coat selected from the group consisting of silicon, silicone, SiO₂, and combinations thereof. For example, the contact surfaces may be coated with SILCOLLOY® (SilcoTek Corporation, Bellefonte, Pa.).

In another embodiment, the concentrated aqueous hydrogen peroxide solution in the boiler is made in situ from the dilute aqueous hydrogen peroxide solution and stored therein prior to use and/or delivery. In another embodiment, the method can include removing contaminants from the dilute vapor by passing the dilute vapor through a steam purification assembly before delivering to a critical process or application, or to a storage vessel. In another embodiment, the steam purification assembly produces a condensate stream from the steam passing therethrough. In another embodiment, the steam purification assembly comprises a plurality of membranes formed from a perfluorinated ion-exchange membrane. In another embodiment, the plurality of membranes are formed from NAFION® membrane. In another embodiment, boiling the aqueous hydrogen peroxide solution is accomplished by controlling the temperature of the concentrated aqueous hydrogen peroxide solution, such as by heating to greater than about 80° C., greater than about 120° C., greater than about 200° C., or greater than about 300° C. In another embodiment, boiling the aqueous hydrogen peroxide solution is accomplished by controlling the pressure of the concentrated aqueous hydrogen peroxide solution. In another embodiment, boiling the aqueous hydrogen peroxide solution is accomplished by controlling the temperature and pressure of the concentrated aqueous hydrogen peroxide solution. In another embodiment, addition of the dilute aqueous hydrogen peroxide solution to the boiler initiates when boiling begins. In another embodiment, the method further comprises adding a stabilizer that is non-volatile or rejected by the purification assembly, i.e., the stabilizer does not pass through the membrane.

Another aspect of the present disclosure is directed to a chemical delivery system comprising a concentrated aqueous hydrogen peroxide solution, a boiler having a head space and configured for boiling the concentrated aqueous hydrogen peroxide solution to produce a dilute vapor comprising hydrogen peroxide within the head space, and a manifold in fluid communication with the boiler and configured for adding a dilute aqueous hydrogen peroxide solution to the concentrated aqueous hydrogen peroxide solution within the boiler to maintain the concentration of the dilute vapor being produced. In various embodiments, the manifold is further configured to deliver the dilute vapor comprising hydrogen peroxide to a critical process or application, or to a storage vessel. In various embodiments, at least one surface, tube or component of the delivery system is formed from a material selected from the group consisting of stainless steel, quartz, nickel, aluminum, hastelloy, and monel, and any contact surfaces (for example, tubing, process vessels, storage vessels, etc.) between the surface, tube or component and the hydrogen peroxide vapor may be subjected to surface modification to minimize decomposition of the hydrogen peroxide gas. In preferred embodiments, the contact surfaces are treated with a surface-coat selected from the group consisting of silicon, silicone, SiO₂, and combinations thereof. For example, the contact surfaces may be coated with SILCOLLOY® (SilcoTek Corporation, Bellefonte, Pa.).

In another embodiment, the concentrated aqueous hydrogen peroxide solution provided in the boiler is made in situ from the dilute aqueous hydrogen peroxide solution. In another embodiment, the manifold further comprises a purification assembly configured to remove contaminants from the dilute vapor. In another embodiment, the purification assembly comprises a plurality of membranes formed from a perfluorinated ion-exchange membrane. In another embodiment, the plurality of membranes are formed from NAFION® membrane. In another embodiment, the boiling of the concentrated aqueous hydrogen peroxide solution is controlled by a heat source configured to heat the boiler to greater than about 80° C., greater than about 120° C., greater than about 200° C., or greater than about 300° C. The heat source may be provided in electrical communication with at least one thermocouple coupled to the boiler. In another embodiment, the boiling of the concentrated aqueous hydrogen peroxide solution is controlled by a pressure transducer and a control valve coupled to the boiler. In another embodiment, the boiling of the concentrated aqueous hydrogen peroxide solution is controlled by controlling the temperature of the aqueous hydrogen peroxide solution in the boiler and pressure of the head space in the boiler. In certain embodiments, the flow rate of the dilute vapor comprising hydrogen peroxide can be monitored by determining the energy used to heat the boiler solution, the change in pressure across an orifice, a combination of those monitoring methods, or any other suitable methods for monitoring gas flow in such systems. In another embodiment, the chemical delivery system can further comprise a stabilizer, which is added to the concentrated aqueous hydrogen peroxide solution, wherein the stabilizer is non-volatile or rejected by the purification assembly, i.e., the stabilizer does not pass through the membrane. In various embodiments, any contact surfaces (for example, process vessels, storage vessels, tubing, valves, etc.) within the chemical delivery system that may come into contact with the hydrogen peroxide vapor may be subjected to surface modification to minimize decomposition of the hydrogen peroxide gas. In preferred embodiments, the contact surfaces are treated with a surface-coat selected from the group consisting of silicon, silicone, SiO₂, and combinations thereof. For example, the contact surfaces may be coated with SILCOLLOY® (SilcoTek Corporation, Bellefonte, Pa.).

In certain embodiments, the hydrogen peroxide concentration in the dilute vapor is between 0.1% to 20% w/w. In certain embodiments, the hydrogen peroxide concentration in the dilute vapor is between 1% to 20% in mole fraction. In certain embodiments, the temperature of the concentrated aqueous hydrogen peroxide solution can be between 30° C. and 130° C. In various embodiments, the pressure of the dilute vapor comprising hydrogen peroxide that is delivered to the critical process or application, or to a storage vessel, is controlled by a downstream valve and delivered at a pressure of up to about 2000 Torr, between about 0.1 Torr to 2000 Torr, between about 1 Torr to 2000 Torr, between about 1 Torr and 1000 Torr. A valve downstream of the boiler or steam purifier assembly (SPA) can be configured according to the requirements of the applicable operating conditions to control the pressure, flow, and concentration of the hydrogen peroxide containing gas stream. In certain embodiments, a downstream valve prevents the mixing of the hydrogen peroxide containing gas stream with other process gases. An example of a valve that is useful for controlling the pressure, flow, and concentration of the hydrogen peroxide containing gas stream is a stepper controlled needle valve. In various embodiments, the valve may be formed from a material selected from the group consisting of stainless steel, quartz, nickel, aluminum, hastelloy, and monel, and any contact surfaces between the valve and the hydrogen peroxide gas may be subjected to surface modification to minimize decomposition of the hydrogen peroxide gas. In preferred embodiments, the contact surfaces are treated with a surface-coat selected from the group consisting of silicon, silicone, SiO₂, and combinations thereof. For example, the contact surfaces may be coated with SILCOLLOY® (SilcoTek Corporation, Bellefonte, Pa.).

In certain embodiments, the methods, systems, and devices of the present invention deliver a vapor comprising hydrogen peroxide and steam without the use of a carrier gas. In certain other embodiments, the vapor comprising hydrogen peroxide and steam includes a carrier gas, e.g., an inert gas may be used to dilute the hydrogen peroxide containing gas stream. In certain other embodiments, the methods, systems, and devices of the present invention deliver hydrogen peroxide to processes or storage vessels at atmospheric or vacuum pressures by controlling the pressure through a valve downstream of the boiler or the SPA, where applicable. In certain other embodiments, any residual steam can be removed from the vapor comprising hydrogen peroxide prior to delivering the hydrogen peroxide vapor to a critical process or application, or to a storage vessel. In various embodiments, at least one surface, tube or component of the delivery system and/or storage vessel is formed from a material selected from the group consisting of stainless steel, quartz, nickel, aluminum, hastelloy, and monel, and any contact surfaces (for example, tubing, process vessels, storage vessels, valves, etc.) of the systems/devices that may come into contact with the hydrogen peroxide vapor may be subjected to surface modification to minimize decomposition of the hydrogen peroxide vapor. In preferred embodiments, the contact surfaces are treated with a surface-coat selected from the group consisting of silicon, silicone, SiO₂, and combinations thereof. For example, the contact surfaces may be coated with SILCOLLOY® (SilcoTek Corporation, Bellefonte, Pa.).

The following examples are intended to illustrate but not limit the invention.

### EXAMPLE 1

### H₂O₂ Vapor Decomposition Determination with Coated Materials

The purpose of this experiment was to determine at what temperature and by how much H₂O₂ vapor will decompose over DURSAN®, SILCOLLOY® 1000, and SILCONERT® 2000 provided by SilcoTek Corporation (Bellefonte, Pa.). A secondary purpose was to find at what temperature H₂O₂ vapor completely decomposes on each coated surface.

A theoretical calibration curve was developed with the FTIR at 3.16 ton that can be used to determine the vapor pressure of H₂O₂ present in a Fourier Transform Infrared Spectroscopy (FTIR) gas cell. This measurement can be used to determine if the presence of certain materials causes decomposition of H₂O₂ at a given temperature by comparing the vapor pressure against that of a blank sample. This method allows for quick determination of whether a coating should be considered for use as a coating for process manifolds intended for use with Brute Peroxide. The following three samples from SilcoTek: DURSAN®, SILCOLLOY® 1000, and SILCONERT® 2000, were potential coatings to be used with Brute Peroxide delivery and were tested in a tube furnace to determine H₂O₂ decomposition at temperatures greater than 100° C.

Test equipment:
Purified nitrogen source
Unit UFC-1000 Mass Flow Controller (MFC-1-1000 SCCM) (Control Range: 50:1 of FS; Accuracy: 1.0% of full scale)
Brooks SLA5850 S-Series Mass Flow Controller (MFC 2-10 SLM) (Control Range: 50:1 of FS; Accuracy: 0.9% of SP for 20-100%FS and 0.18% of FS for 2-20%FS)
4-1/3 PSI check valve (CV-1, CV-2, CV-3, and CV-4)
Brute Peroxide Vaporizer (Rasirc P/N 100742)
Stabilized Brute Peroxide solution (900 g)
2-stainless steel diaphragm valves attached to vaporizer lid (V-1 and V-2)
PFA ball valve (V-3)
Stainless steel needle valve (V-4)
5-3-way PFA pneumatic valves (PV-1-PV-5)
Forward pressure regulator (FP-1)
Stainless steel J-type thermocouple (Range: 0-750° C., Accuracy: greater of 2.2° C. or 0.75%)
Tube furnace (MTI Corp., GSL-1100X)
Wika 0-25 PSIA pressure transducer (PT-1)-[Accuracy <0.5% of span, Hysteresis <0.1% of span]
Heat tracing materials
H₂O₂ scrubber comprised of Carulite 200 4×8
ThermoScientific Nicolet iS10 FTIR with gas cell

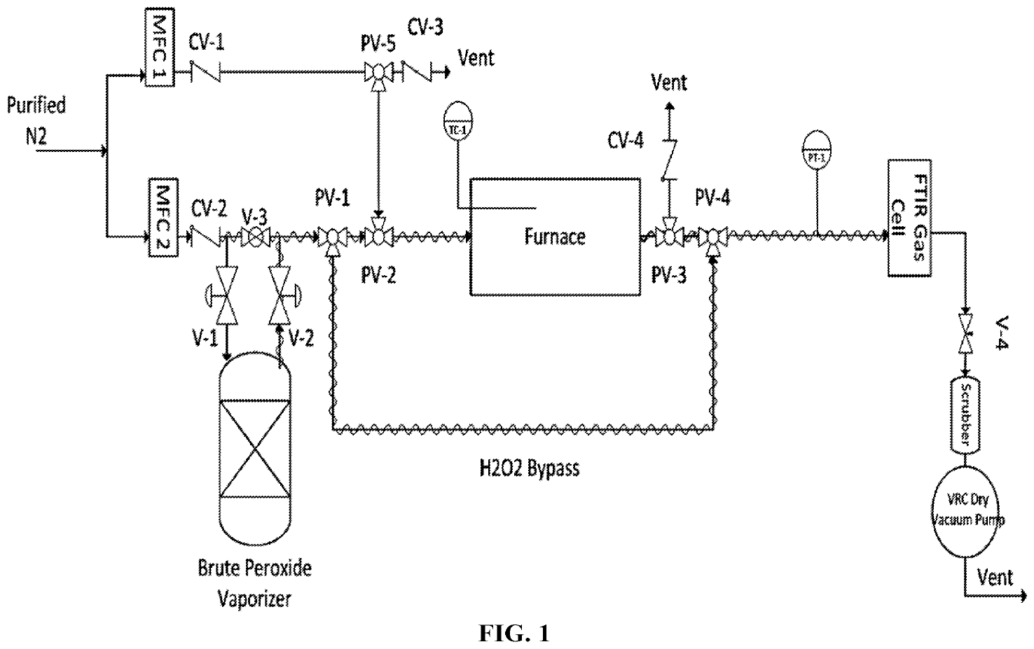

FIG. 1 shows the P&ID for the test setup. Purified nitrogen was maintained at 25 PSIG using a forward pressure regulator. A 1000 SCCM Unit Mass Flow Controller (MFC-1) was used to supply zero gas to the test setup. A 200 SCCM Brooks Mass Flow Controller (MFC-2) was used to supply 15 SCCM of carrier gas. Two 1/3 psi check valves (CV-1 and CV-2) were used to protect the MFCs from chemical exposure. A Brute Peroxide Vaporizer (BPV) with lid was used as the H₂O₂ source for this experiment. Two stainless steel diaphragm valves (V-1 and V-2) attached to the BPV's lid were used to isolate the BPV in between tests. Two 3-way pneumatic PFA valves (PV-1 and PV-4) were used to deliver BPV output to the furnace or to bypass. Three 3-way PFA pneumatics valves (PV-2, PV-3, and PV-5) were used to send zero gas to the furnace or to vent. Two 1/3 PSI check valves (CV-3 and CV-4) were placed on the zero gas vents to prevent atmospheric gasses from entering the test setup. All five pneumatic valves (PV1-PV-5) were controlled and actuated by the same switch. A PFA ball valve (V-3) was used to bypass the BPV and send zero gas to the furnace. A MTI Corp. GSIL-1100X tube furnace was used to house and heat the test material. A stainless steel J-type thermocouple was used to determine the furnace's temperature profile prior to testing with H₂O₂. A Wika 0-25 PSIA pressure transducer (PT-1) was used to monitor the pressure upstream of the FTIR gas cell. A ThermoScientific Nicolet iS10 FTIR fixed with a gas cell was used to measure the absorbance of the BPV process gas. The Omnic and TQ Analyst software provided with the FTIR was used to record and measure the FTIR results. A scrubber comprised of Carulite 200 4×8 was used to decompose any H₂O₂ into H₂O and O₂. A VRC dry vacuum pump was used to apply vacuum to the test setup. A stainless steel needle valve (V-4) was used to meter the vacuum applied to the gas cell as read by PT-1 and isolate the manifold from vacuum if needed. The entire setup upstream of the pump was setup in a fume hood. The pump was used to vent into the fume hood. PT-1 was recorded using a PLC and Terraterm software. The FTIR was collected and analyzed using Omnic and TQ Analyst software provided with the FTIR.

Test Procedure:
1. Close V-1, V-2, V-3 and V-4
2. Set heat tracing to 100° C.
3. Turn on VRC dry vacuum pump
4. Turn on furnace to 150° C.
5. Ensure pneumatic valves are set to send BPV process to furnace and zero gas to vent
6. Set MFC 1 to 15 SCCM
7. Open V-3 and set MFC-2 to 15 SCCM
8. Open V-4 ¼ turn
9. Adjust V-4 until PT-1 reads 3 torr
10. Fill FTIR with liquid nitrogen and ensure the bench has a peak-to-peak reading of at least 8
11. Using the Omnic software take a background sample of the dry nitrogen through the empty furnace
12. Record this value and use as the background for the remainder of testing
13. Open V-2 and V-1 and close V-3
14. Allow process to run for 15-minutes to ensure stability
15. Using the Omnic software, collect a sample of the vapor stream at least 3 times (5-minutes apart)
16. Record the results in step 15 as the baseline H₂O₂ reading
17. Switch BPV output to bypass and zero gas to furnace
18. Insert copper sheeting into furnace
19. Switch BPV output to furnace and zero gas to bypass
20. Allow system to run for 15 minutes to ensure stability
21. Using the Omnic software, collect a sample of the vapor stream at least 3 times (5-minutes apart)
22. Record the results in step 21 as the copper sample
23. Switch BPV to bypass and zero gas to furnace
24. Remove copper sheet from furnace
25. Switch BPV output to furnace and zero gas to bypass
26. Repeat steps 14-25 as needed for repeatability
27. Repeat steps 14-26 for Dursan®, Silcolloy® 1000 and Silconert® 2000
28. When testing is complete, switch BPV output to bypass and zero gas to furnace
29. Turn furnace off
30. Close V-1 and V-2 and Open V-3
31. Allow manifold to purge with purified nitrogen

Tables 1 and 2 show the results in percent H₂O₂ decomposed and the partial pressure measured by the developed calibration curve. Copper was run at 150° C. as a control to ensure decomposition was measurable and quantifiable under the current test configuration. Neither SILCOLLOY® nor SILCONERT® showed decomposition at 150° C. whereas DURSAN® decomposed H₂O₂ at 150° C. by 6%. SILCONERT® fully decomposed H₂O₂ at 200° C. while DURSAN® and SILCOLLOY® decomposed H₂O₂ by 94% and 91%. Both DURSAN® and SILCOLLOY® fully decomposed H₂O₂ at 225° C.

TABLE 1
Percent H₂O₂ Decomposed for each
Material and Temperature Tested

| | Temp ° C. | | | | | |
|---|---|---|---|---|---|---|
| Material | 150 | | 200 | | 225 | |
| Cu | 90 | ♦ | NT | | NT | |
| Dursan | 6 | ♦ | 94 | ♦ | 100 | □ |
| Silcolloy | 0 | * | 91 | ♦ | 100 | □ |

| | | | | | |
|---|---|---|---|---|---|
| Silconert | 0 | * | 100 | □ | NT |

Decomposition Key: NT not tested; * no; ♦ partial; □ Total

TABLE 2
H₂O₂ Partial Pressure in Torr for Each
Material and Temperature Tested

| | Temp ° C. | | | | | |
|---|---|---|---|---|---|---|
| Material | 150 | | 200 | | 225 | |
| Cu | 0.10 | ♦ | NT | | NT | |
| Dursan | 0.90 | ♦ | 0.06 | ♦ | 100 | □ |
| Silcolloy | 0.96 | * | 0.09 | ♦ | 100 | □ |

| | | | | | |
|---|---|---|---|---|---|
| Silconert | 0.84 | * | 0.00 | □ | NT |

Decomposition Key: NT not tested; * no; ♦ partial; □ Total

A 10″ long piece of ¼″ diameter stainless steel tubing was sent to SilcoTek to be coated with SILCOLLOY®1000. The tubing was installed into the test setup in replacement of the oven in FIG. 1. The same length of PFA and SULFINERT® (SILCONERT® 2000) were also tested to provide a direct comparison for the Silcolloy®1000 results. Tables 3 and 4 show the results of this experiment in percent decomposition and partial pressure of H₂O₂, respectively. The PFA was heated to 225° C. with no signs of decomposition while the results show a 42% H₂O₂ decomposition at 200° C. with PFA. The SULFINERT® did not show the inherent H₂O₂ decomposition at 60° C. and 100° C. Without being bound by theory, there are two possible reasons for these results. First, this may have resulted from the lower initial vapor pressure of H₂O₂ during this testing of approximately 30% (Previous: 0.86torr, Current: 0.61torr). Second, the test manifold and PFA tubing were constructed from different components from those used in a previous test manifold. Therefore, the previous manifold may have had metal contamination that was not present in the current manifold. Similar to the previous results, the SULFINERT® did partially decompose H₂O₂ at 150° C. and fully decomposed H₂O₂ at 175° C. SILCOLLOY® 1000 was heated up to 300° C. without any sign of decomposition.

TABLE 3
H₂O₂ Percent H₂O₂ Decomposed for each Material and
Temperature Tested

| | Temp ° C. | | | | | | | |
|---|---|---|---|---|---|---|---|---|
| Material | 60 | 100 | 150 | 175 | 200 | 225 | 250 | 300 |
| Silcolloy | 0 * | 0 * | 0 * | NT | 0 * | NT | 0 * | 0 * |
| 1000 [symbol] | | | | | | | | |
| Sulfinert 2 | 0 * | 0 * | 62 ♦ | 100 □ | NT | NT | NT | NT |
| PFA 2 | 0 * | 0 * | 0 * | NT | 0 | 0 | NT | NT |

Decomposition Key: NT not tested; * no; ♦ partial; □ Total [symbol]
Tested at different time with lower H₂O₂ concentration in BPV output

TABLE 4
H₂O₂ Partial Pressure in Torr for Each Material and
Temperature Tested

| | Temp ° C. | | | | | | | |
|---|---|---|---|---|---|---|---|---|
| Material | 60 | 100 | 150 | 175 | 200 | 225 | 250 | 300 |
| Silcolloy | 0.61 * | 0.61 * | 0.61 * | NT | 0.61 * | NT | 0.61 * | 0.61 * |
| 1000 [symbol] | | | | | | | | |
| Sulfinert 2 | 0.61 * | 0.61 * | 0.38 ♦ | 0.00 □ | NT | NT | NT | NT |
| PFA 2 | 0.61 * | 0.61 * | 0.61 * | NT | 0.61 | 0.61 | NT | NT |

Decomposition Key: NT not tested; * no; ♦ partial; □ Total [symbol]
Tested at different time with lower H₂O₂ concentration in BPV output

Conclusions: SILCONERT® decomposed H₂O₂ completely at 200° C.; DURSAN® decomposed H₂O₂ at 200° C. by 6%; DURSAN® and SILCOLLOY® fully decomposed H₂O₂ at 225° C.; DURSAN® and SILCOLLOY® decomposed H₂O₂ at 200° C. by 94% and 91%.

The PFA tubing showed no H₂O₂ decomposition up to 225° C.; the SULFINERT® (SILCONERT® 2000) tubing partially decomposed H₂O₂ at 150° C. and fully decomposed H₂O₂ at 175° C.; and SILCOLLOY® 1000 tubing showed no signs of H₂O₂ decomposition up to 300° C.

### EXAMPLE 2

### H₂O₂ Vapor Decomposition Determination with SILCOLLOY Coated SS

The purpose of this experiment was to determine the percent decomposition of Brute Peroxide vapor through a 3-meter, ½″ ID, SILCOLLOY-coated stainless steel tube under vacuum pressure at different temperatures.

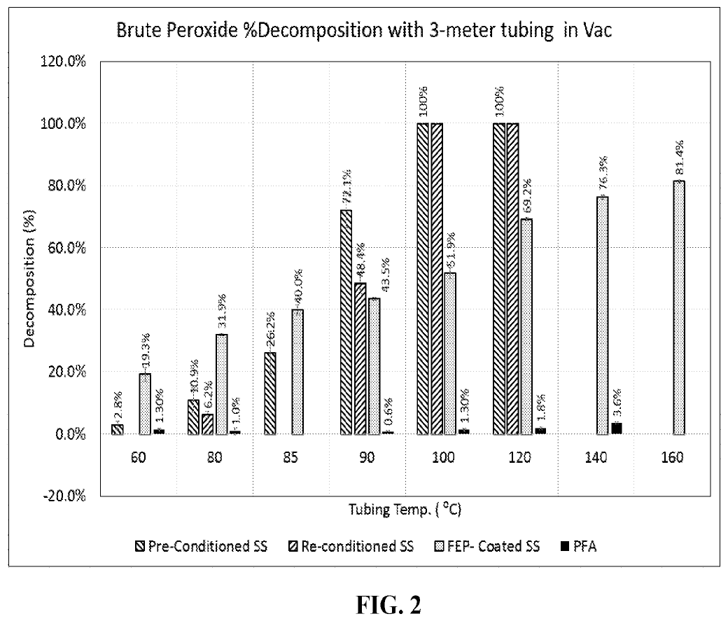

Previous studies have been done on Brute Peroxide vapor compatibility with PFA (Perfluoroalkoxy alkane), pre-conditioned stainless steel (SS), and fluorinated ethylene propylene copolymer (FEP)-coated stainless steel. In a previous study, the brute peroxide percent decomposition was determined for a 3-meter coiled, ½″ ID tubing of PFA, pre-conditioned SS, and FEP-coated SS at different temperatures vacuum pressure using a FTIR. FIG. 2 represents these results. In this report, the compatibility of brute peroxide vapor with SILICOLLOY-coated material was investigated. The ultimate goal was to determine the percent decomposition of brute peroxide vapor for a 3-meter coiled ½″ ID SILCOLLOY-coated SS tubing at different temperatures.

A theoretical calibration curve was developed with the FTIR at 3.16 ton that could be used to qualitatively determine the vapor pressure of H₂O₂ present in a FTIR gas cell. This measurement was used to determine if Brute H₂O₂ vapor decomposes in contact with heated SILCOLLOY-coated SS at a given temperature. This was done by comparing H₂O₂ vapor pressure reading from FTIR when the H₂O₂ vapor flows through the coated SS against the PFA. This method allowed for quick determination of whether the SILICOLLOY coating should be considered for use as a coating for Brute Peroxide's process manifolds.

Test Equipment:
Purified nitrogen source
Unit UFC-1000 Mass Flow Controller (MFC-1-1000 SCCM) (Control Range: 50:1 of FS; Accuracy: 1.0% of full scale)
Brooks SLA5850 S-Series Mass Flow Controller (MFC 2-10 SLM) (Control Range: 50:1 of FS; Accuracy: 0.9% of SP for 20-100%FS and 0.18% of FS for 2-20%FS)
4-1/3 PSI check valve (CV-1, CV-2, CV-3, and CV-4)
Brute Peroxide Vaporizer (Rasirc P/N 100742)
Stabilized Brute Peroxide solution (900 g)
2-stainless steel diaphragm valves attached to vaporizer lid (V-1 and V-2)
PFA ball valve (V-3)
Stainless steel needle valve (V-4)
5-3-way PFA pneumatic valves (PV-1-PV-5)
Forward pressure regulator (FP-1)
One PFA coated J-type thermocouple (TC-1) (Range: 0-750° C., Accuracy: greater of 2.2° C. or 0.75%)
3-meter coiled Silcolloy coated SS tubing with ½′ OD
2-Wika 0-25 PSIA pressure transducer2 (PT-1) , (PT-2)-[Accuracy <0.5% of span, Hysteresis <0.1% of span]
Heat tracing materials
H₂O₂ scrubber comprised of Carulite 200 4×8
ThermoScientific Nicolet iS10 FTIR with gas cell

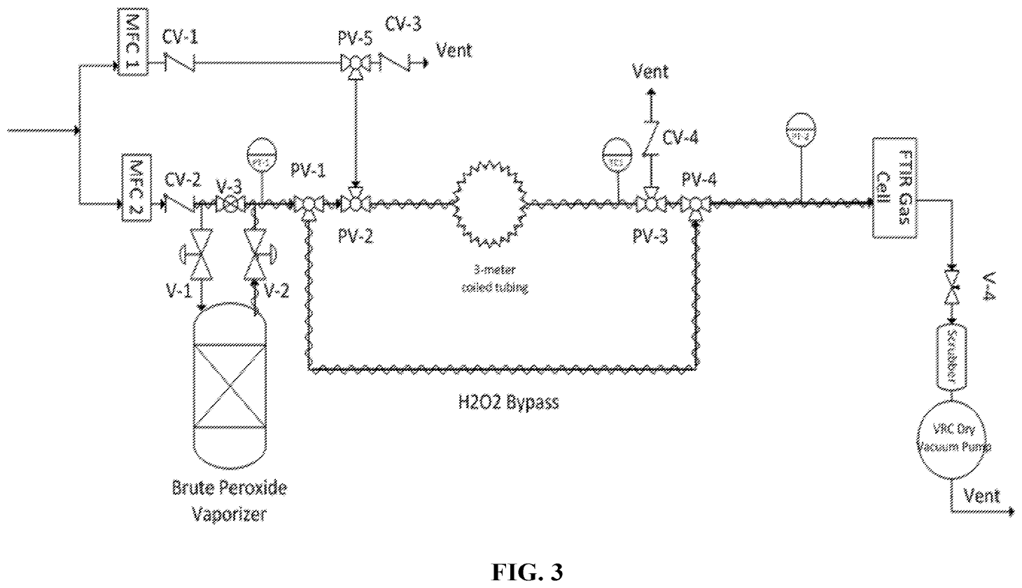

FIG. 3 shows the P&ID for the test setup. Purified nitrogen was maintained at 25 PSIG using a forward pressure regulator. A 1000 SCCM Unit Mass Flow Controller (MFC-1) was used to supply 50sccm zero gas to the test setup. A 200 SCCM Brooks Mass Flow Controller (MFC-2) was used to supply 15 SCCM of carrier gas. Two 1/3 psi check valves (CV-1 and CV-2) were used to protect the MFCs from chemical exposure. A Brute Peroxide Vaporizer (BPV) with lid was used as the H₂O₂ source for this experiment. This is the same vaporizer used previously, but refilled with new solution. Two stainless steel diaphragm valves (V-1 and V-2) attached to the BPV's lid were used to isolate the BPV in between tests. A Wika 0-25 PSIA pressure transducer (PT-1) was placed downstream of the BPV to monitor the downstream pressure. Two 3-way pneumatic PFA valves (PV-1 and PV-4) were used to deliver BPV output to the 3-meter coiled tubing or to the PFA bypass line. Three 3-way PFA pneumatics valves (PV-2, PV-3, and PV-5) were used to send zero gas to the coiled tubing or to vent. Two 1/3 PSI check valves (CV-3 and CV-4) were placed on the zero gas vents to prevent atmospheric gasses from entering the test setup. As above, all five pneumatic valves (PV1-PV-5) were controlled and actuated by the same switch. A PFA ball valve (V-3) was used to bypass the BPV and send N₂ gas to the manifold. A 3-meter coiled SILCOLLOY-coated SS was placed downstream of the BPV. The coiled tubing was heat traced. A 2′ PFA tubing was placed downstream of BPV as a bypass. A Wika 0-25 PSIA pressure transducer (PT-2) was used to monitor the pressure upstream of the FTIR gas cell. A ThermoScientific Nicolet iS10 FTIR fixed with a gas cell was used to measure the absorbance of the BPV process gas. The Omnic and TQ Analyst software provided with the FTIR was used to record and measure the FTIR results. A scrubber comprised of Carulite 200 4×8 was used to decompose any H₂O₂ into H₂O and O₂. A VRC dry vacuum pump was used to apply vacuum to the test setup. A stainless steel needle valve (V-4) was used to meter the vacuum applied to the gas cell as read by PT-2 and isolate the manifold from vacuum if needed. The entire setup upstream of the pump was setup in a fume hood. The pump was vented into the fume hood. PT-1, PT-2 were recorded using a PLC and Terraterm software. The FTIR was collected and analyzed using Omnic and TQ Analyst software provided with the FTIR.

Test Procedure:
SILCOLLOY-Coated Stainless Steel Tubing:
   1. Close V-1, V-2, V-3 and V-4
   2. Set all the temperature zoon in the test manifold to 100° C., except the 3M tubing
   3. Set the 3M tubing to the temperatures corresponded to each tests listed in Table 3
   4. Turn on VRC dry vacuum pump
   5. Ensure pneumatic valves are set to send BPV process to the PFA tubing
   6. Set MFC 1 to 15 SCCM
   7. Open V-3 and set MFC-2 to 15 SCCM
   8. Open V-4 ¼ turn
   9. Adjust V-4 until PT-2 reads 3.16 torr
   10. Fill FTIR with liquid nitrogen and ensure the bench has a peak-to-peak reading of at least 8
   11. Using the Omnic software take a background sample of the dry nitrogen through the PFA tubing
   12. Record this value and use as the background for the remainder of testing
   13. Open V-2 and V-1 and close V-3
   14. Allow process to run for 15-minutes to ensure stability
   15. Using the Omnic software, collect a sample of the vapor stream
   16. Record the results in step 15 as the PFA-H₂O₂ reading
   17. Switch BPV output to the coiled SS tubing
   18. Allow process to run for 15-minutes to ensure stability
   19. Using the Omnic software, collect a sample of the vapor stream
   20. Record the results in step 15 as the SS-H₂O₂ reading
   21. Switch BPV output to PFA and zero gas to the SS
   22. Repeat step 14 to 21, 3 times
   23. Close V-1 and V-2 and open V-3
   24. Changed the temperature of the SS to the next setpoint from Table 1
   25. Wait until the SS reaches the temperature setpoint
   26. Repeat steps 13 to 22 for all the setpoints in Table 1
   27. When testing is complete, switch BPV output to PFA and zero gas to the SS
   28. Close V-1 and V-2 and Open V-3
   29. Allow manifold to purge with purified nitrogen

TABLE 5
Test parameters.

| | Carrier gas | Pressure | 3M-Tubing |
|---|---|---|---|
| Test | Flowrate | on PT1 | Temperature-set |
| # | (sccm) | (torr) | points (C.) |
| 1 | 15 | 3.16 | 60 |
| 2 | 15 | 3.16 | 80 |
| 3 | 15 | 3.16 | 90 |
| 4 | 15 | 3.16 | 100 |
| 5 | 15 | 3.16 | 120 |
| 6 | 15 | 3.16 | 140 |
| 7 | 15 | 3.16 | 160 |
| 8 | 15 | 3.16 | 180 |
| 9 | 15 | 3.16 | 200 |
| 10 | 15 | 3.16 | 225 |

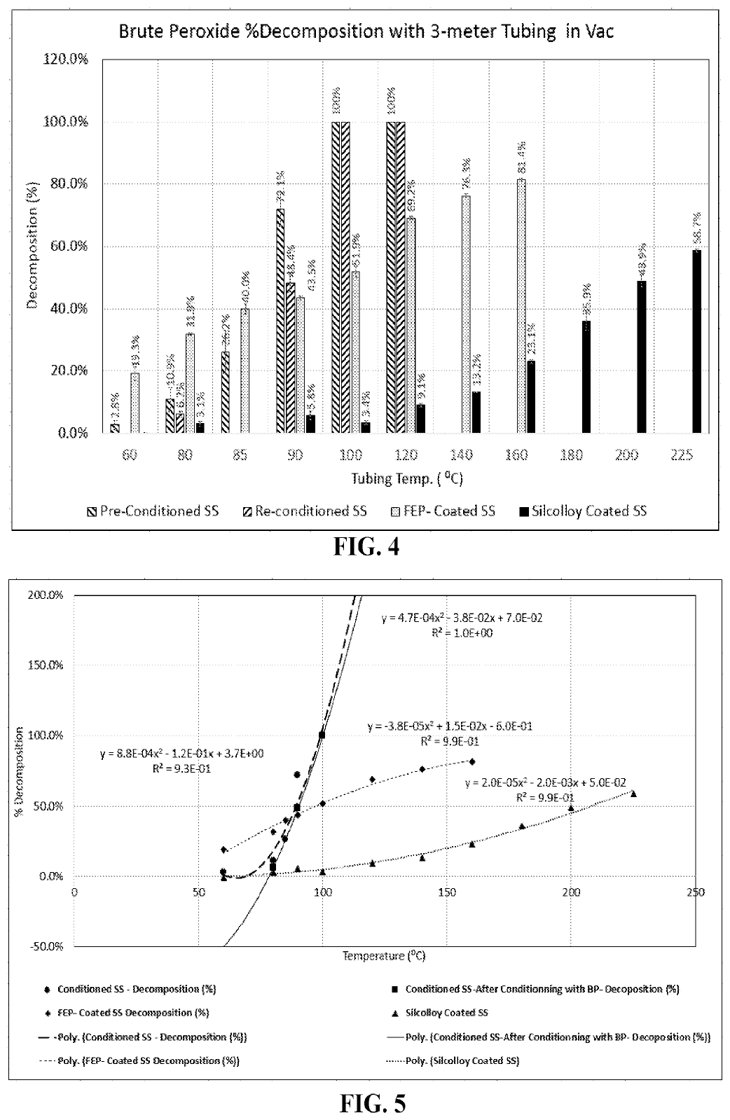

Table 5 represents the Brute Peroxide decomposition results with the SILCOLLOY-coated SS at different temperatures. For all the decomposition tests, the carrier gas flowrate was 0.015 slm of N₂. For all the runs the pressure at PT2 was maintain at 3.157 torr. The Brute peroxide vaporizer was at room temperature. The average peroxide concentration through the PFA tubing (the baseline) was about 312377±68850 ppm in vacuum. For a direct comparison of these results with the previous results with the other materials, all the results are combined and presented in form of a bar graph in FIG. 4.

As shown in FIG. 4, the x-axis shows the temperature setpoint to which the 3-meter tubing was heated. The y-axis represents the percent difference in peroxide vapor pressures when the Brute Peroxide output was switched from the bypass (a 2′ PFA tubing heated to 100° C.) to the 3-meter tubing. Different bar colors in the graph represent different tubing material or coating. As shown, the peroxide decomposition with all the test materials was increased as the temperature of the tubing increased. For the temperatures below 120° C., the maximum % decomposition with SILCOLLOY-coated tubing was about 5.8% at 90° C. It must be taken into consideration that the BVP output was very low (0.75 torr) for this run. Therefore, the % decomposition measurement might not be within the accuracy of the current method. At 120° C., the % decomposition with SILCOLLOY was about 90% and 84% better than Pre-Conditioned SS and FEP-coated SS, respectively.

Comparing all the decomposition rate results for the Pre-conditioned SS, FEP-coated SS, and SILCOLLOY-coated SS, it can be concluded that the decomposition rate with SILCOLLOY-coated SS was the lowest at any given temperatures.

TABLE 6
Brute Peroxide Decomposition results with 3-meter SILCOLLOY-Coated
SS and PFA under Vacuum Pressure.

| | | | | | H2O2 | H2O2 | | |
|---|---|---|---|---|---|---|---|---|
| | | PFA- | SC-SS- | Downstream | Vap- | Vap- | Avg- | % |
| | | Upstream | Upstream | pressure | Pressure | Pressure | % | Decom- |
| SC-SS | Room-T | Pressure- | Pressure- | PT2 | in PFA | in SC-SS | Decom- | position |
| Temp (° C.) | (° C.) | PT1 (torr) | PT1 (torr) | (torr) | (torr) | (torr) | position | STDEV |
| 60 | 30.2 | 7.89 | 8.21 | 3.16 | 0.615 | 0.620 | −0.8% | 1.1% |
| 80 | 29.5 | 7.89 | 8.53 | 3.16 | 0.85 | 0.82 | 3.1% | 0.8% |
| 90 | 29.1 | 7.58 | 8.21 | 3.16 | 0.75 | 0.70 | 5.8% | 1.3% |
| 100 | 30.0 | 8.21 | 8.84 | 3.16 | 1.01 | 0.97 | 3.4% | 0.6% |
| 120 | 30.8 | 8.21 | 8.84 | 3.16 | 0.92 | 0.84 | 9.1% | 0.5% |
| 140 | 33.4 | 8.21 | 9.16 | 3.16 | 1.03 | 0.90 | 13.2% | 0.2% |
| 160 | 32.5 | 9.00 | 9.63 | 3.16 | 1.22 | 0.94 | 23.1% | 0.8% |
| 180 | 30.7 | 8.21 | 9.16 | 3.16 | 0.98 | 0.63 | 35.9% | 2.7% |
| 200 | 33.6 | 9.16 | 9.79 | 3.16 | 1.15 | 0.58 | 48.9% | 2.0% |
| 225 | 34.1 | 9.16 | 9.79 | 3.16 | 1.34 | 0.55 | 58.7% | 0.6% |

The decomposition results for SILCOLLOY-coated tubing follows a general trend that can be fitted to a Regression Polynomial model. FIG. 4 represents this model along with the previous models for the previous materials. For a 3-meter, ½″ ID tubing of SILCOLLOY-coated SS, the % decomposition of Brute Peroxide with an average delivered peroxide concentration of 312K ppm, 15 sccm carrier gas flowrate under 3.16 torr pressure, can be calculated using the quadratic equation presented below:

% Decomposition=2.0E-05T²−2.0E-03T+5.0E-02

where T: is the surface Temperature (° C.) for 60° C. <T<225° C.; % D: Percent decomposition of brute peroxide vapor in a contact with the material at temperature T; % D >100% means complete decomposition; and % D<3% means no decomposition.

In this study, the decomposition rate of Brute Peroxide for 3-meters of ½″ ID tubing of SILCOLLOY-coated SS at different temperatures under vacuum pressure was determined. The pressure and the carrier gas flow rate was maintained at 3.16 torr and 15 sccm for all the tests, respectively. The results illustrate the effects of temperature and material on the Brute Peroxide decomposition. It can therefore be concluded that the SILCOLLOY-coated SS is the best choice for delivering the Brute Peroxide vapor at any temperatures below 225° C. under vacuum.

TABLE 7
Brute Peroxide Decomposition Study's Test Parameters with 3-meter
SILCOLLOY-Coated SS Tubing.

| Experimental | | | | | | | | Theoretical | | | |
|---|---|---|---|---|---|---|---|---|---|---|---|
| | | | | | H2O2 | H2O2 | | | | RL-H2O | |
| | | PFA- | SC-SS- | | Vap- | Vap- | Avg- | | | Vapor | |
| Carrier | Downstream | Upstream | Upstream | | Pressure | Pressure | % | Corre- | RL-H2O2 | P (2% | RL-H2O2 |
| Gas GR | pressure PT2 | Pressure- | Pressure- | SS-Temp | in PFA | in SC-SS | Decom- | sponding | Vapor P | water) | (ppm) |
| (slm) | (torr) | PT1 (torr) | PT1 (torr) | (° C.) | (torr) | (torr) | position | RL-T (C.) | (torr) | (torr) | in PFA |
| 0.015 | 3.16 | 7.89 | 8.21 | 60 | 0.615 | 0.620 | −0.8% | 15.8% | 0.615 | 1.27 | 194774 |
| 0.015 | 3.1 [symbol] | 7.89 | 8.53 | 80 | 0.85 | 0.82 | 3.1% | 20.1 | 0.85 | 1.66 | 268672 |
| 0.015 | 3.16 | 7.58 | 8.21 | 90 | 0.75 | 0.70 | 5.8% | 18.4 | 0.75 | 1.50 | 237529 |
| 0.015 | 3.16 | 8.21 | 8.84 | 100 | 1.01 | 0.97 | 3.4% | 22.5 | 1.01 | 1.93 | 319344 |
| 0.015 | 3.16 | 8.21 | 8.8 [symbol] | 120 | 0.92 | 0.84 | 9.1% | 23.2 | 0.92 | 1.78 | 29 [symbol] 897 |
| 0.015 | 3.16 | 8.21 | 9.16 | 140 | 1.03 | 0.90 | 13.2% | 22.7 | 1.03 | 1.95 | 327262 |
| 0.015 | 3.16 | 9.00 | 9.63 | 150 | 1.22 | 0.94 | 23.1% | 25.4 | 1.22 | 2.25 | 385908 |
| 0.015 | 3.16 | 8.21 | 9. [symbol] | 180 | 0.98 | 0.63 | 35.9% | 22.0 | 0.98 | 1.87 | 310371 |
| 0.015 | 3.1 [symbol] | 9.16 | 9.79 | 200 | 1.15 | 0.58 | [symbol] .9% | 24.3 | 1.15 | 2.15 | 362628 |
| 0.015 | 3.16 | 9.26 | 9.79 | 225 | 1.34 | 0. [symbol] | 58.7% | 26.4 | 1.34 | 2.43 | 424385 |

[symbol]

indicates data missing or illegible when filed

### EXAMPLE 3

### Surface Analysis of SILCOLLOY Coated SS

The goal of this analysis was to determine the composition and chemistry of a coating inside a stainless steel tube.

X-ray Photoelectron Spectroscopy (XPS), also known as Electron Spectroscopy for Chemical Analysis (ESCA), is used to determine quantitative atomic composition and chemistry. XPS works by irradiating a sample with monochromatic X-rays, resulting in the emission of photoelectrons whose energies are characteristic of the elements and their chemical/oxidation state, and the intensities of which are reflective of the amount of those elements present within the sampling volume. Photoelectrons are generated within the X-ray penetration depth (typically many microns), but only photoelectrons within the top ˜50-100Å are detected. Detection limits are approximately 0.05 to 1.0 atomic %. Major factors affecting detection limits are the element itself (heavier elements generally have lower detection limits), interferences (which can include other photoelectron peaks and Auger electron peaks from other elements) and background (mainly caused by signal from electrons that have lost energy to the matrix).

The coating was found to be composed primarily of elemental Si (Si⁰), lower levels of SiO₂, silicone, and other organic species. The atomic composition is found in Table 8 and the Si bonding states are presented in Table 9. Carbon was found primarily as hydrocarbon with lower levels of carbon-oxygen functionalities. The low levels of silicone indicated by the Si spectrum appear at the same binding energy as hydrocarbon. The levels of oxygen were higher than expected for the species identified thus far. This indicates the possible presence of —OH groups (perhaps adsorbed water) on the coating.

TABLE 8
Atomic Concentrations (in atomic %)^{a}

| | C | O | Si |
|---|---|---|---|
| tube | 25.3 | 35.0 | 39.8 |

^{a}Normalized to 100% of the elements detected.

TABLE 9
Silicon Chemical States

| | in % of Total Si^{a} | | | In atomic % Si | | |
|---|---|---|---|---|---|---|
| | Si⁰ | silicone | SiO² | Si | silicone | SiO² |
| tube | 70 | 8 | 22 | 27.9 | 3.1 | 8.8 |

^{a}Values in this table are percentages of the total atomic concentration of the corresponding element shown in Table 5

Although the invention has been described with reference to the above example, it will be understood that modifications and variations are encompassed within the spirit and scope of the invention. Accordingly, the invention is limited only by the following claims.

1. A method comprising:
(a) providing in an enclosed chamber a hydrogen peroxide solution having a vapor phase;
(b) contacting a carrier gas or vacuum with the vapor phase to form a gas stream; and
(c) delivering the gas stream comprising at least 1000 parts per million (ppm) hydrogen peroxide gas to a critical process, application or storage vessel, wherein at least one component selected from the group consisting of a surface of the chamber, a tube in fluid communication with the chamber, or a surface of the storage vessel has previously undergone surface modification.

2. The method of claim 1, wherein the hydrogen peroxide solution is non-aqueous.

3. The method of claim 1, wherein the hydrogen peroxide solution has a vapor phase separated from the hydrogen peroxide solution by a membrane.

4. The method of claim 1, wherein the at least one component is formed from a material selected from the group consisting of stainless steel, quartz, nickel, aluminum, hastelloy, and monel, and wherein any contact surface between the component and the gas stream is treated with a surface-coat selected from the group consisting of silicon, silicone, SiO₂, and any combination thereof.

5. The method of claim 3, wherein the membrane is an ion exchange membrane.

6. The method of claim 4, wherein the at least one component is heated to between 30° C. and about 300° C.

7. The method of claim 4, wherein the at least one component is heated to between 80° C. and about 200° C.

8. The method of claim 6, wherein pressure within the at least one component is between 0.75 Torr and 760 Torr.

9. The method of claim 1, further comprising adding a dilute aqueous hydrogen peroxide solution to the hydrogen peroxide solution within the enclosed chamber.

10. A chemical delivery system comprising:
(a) a hydrogen peroxide solution provided within an enclosed chamber, wherein the hydrogen peroxide solution has a vapor phase separated from the hydrogen peroxide solution by a membrane within the chamber;
(b) a carrier gas or vacuum in fluid contact with the vapor phase, thereby forming a gas stream within the chamber; and
(c) an apparatus in fluid communication with the chamber and configured for delivering the gas stream comprising at least 1000 ppm hydrogen peroxide to a critical process, application or storage vessel, wherein any contact surface between the apparatus and the gas stream is treated with a surface-coat selected from the group consisting of silicon, silicone, SiO₂, and combinations thereof.

11. The method of claim 10, wherein the hydrogen peroxide solution is non-aqueous.

12. The method of claim 10, wherein the hydrogen peroxide solution is aqueous.

13. The chemical delivery system of claim 10, wherein at least one of the chamber, apparatus or storage vessel is formed from a material selected from the group consisting of stainless steel, quartz, nickel, aluminum, hastelloy, and monel.

14. The chemical delivery system of claim 10, wherein the membrane is an ion exchange membrane.

15. The chemical delivery system of claim 10, wherein the chamber is heated to between 30° C. and about 300° C.

16. The chemical delivery system of claim 10, wherein the chamber is heated to between 80° C. and about 200° C.

17. The chemical delivery system of claim 10, further comprising adding a dilute aqueous hydrogen peroxide solution to the hydrogen peroxide solution within the enclosed chamber.

18. A hydrogen peroxide delivery device comprising:
(a) a housing having within it at least one membrane;
(b) a hydrogen peroxide liquid solution contained within the housing; and
(c) a head space contained within the housing and separated from the hydrogen peroxide solution by the at least one membrane,
wherein the housing is configured to allow a carrier gas to flow through the head space to produce a gas stream comprising at least 1000 ppm hydrogen peroxide to a critical process, application or storage vessel, and wherein any contact surface between the housing and the gas stream is formed from a material selected from the group consisting of stainless steel, quartz, nickel, aluminum, hastelloy, and monel.

19. The method of claim 18, wherein the hydrogen peroxide solution is non-aqueous.

20. The method of claim 18, wherein the hydrogen peroxide solution is aqueous.

21. The hydrogen peroxide delivery device of claim 18, wherein any component formed from stainless steel, quartz, nickel, aluminum, hastelloy, or monel is treated with a surface-coat selected from the group consisting of silicon, silicone, SiO₂, and combinations thereof.

22. The hydrogen peroxide delivery device of claim 18, further comprising a container in fluid communication with the housing and configured to add a dilute aqueous hydrogen peroxide solution to the hydrogen peroxide solution within the housing.

23. The hydrogen peroxide delivery device of claim 18, further comprising a heater configured to heat the housing to between 30° C. and about 300° C.

24. The hydrogen peroxide delivery device of claim 23, wherein the heater is configured to heat the housing to between 80° C. and about 200° C.

25. A method comprising:
(a) providing a concentrated aqueous hydrogen peroxide solution in a boiler having a head space;
(b) heating the concentrated aqueous hydrogen peroxide solution to produce a dilute vapor comprising hydrogen peroxide within the head space of the boiler;
(c) adding a dilute aqueous hydrogen peroxide solution to the concentrated aqueous hydrogen peroxide solution within the boiler to maintain the concentration of the aqueous hydrogen peroxide solution in the boiler; and
(d) delivering the dilute vapor comprising hydrogen peroxide to a critical process, application or storage vessel, wherein at least one component selected from the group consisting of a surface of the chamber, a tube in fluid communication with the chamber, or a surface of the storage vessel has previously undergone surface modification.

26. The method of claim 25, wherein the at least one component is formed from a material selected from the group consisting of stainless steel, quartz, nickel, aluminum, hastelloy, and monel, and wherein any contact surface between the component and the gas stream is treated with a surface-coat selected from the group consisting of silicon, silicone, SiO₂, and any combination thereof.

27. The method of claim 25, wherein at least one component is heated to between 30° C. and about 300° C.

28. The method of claim 25, wherein at least one component is heated to between 80° C. and about 200° C.

29. The method of claim 25, wherein pressure within the at least one component is between 0.75 Torr and 1000 Torr.

30. A chemical delivery system comprising:
(a) a concentrated aqueous hydrogen peroxide solution;
(b) a boiler having a head space configured for boiling the concentrated aqueous hydrogen peroxide solution and producing a dilute vapor comprising hydrogen peroxide within the head space; and
(c) a manifold in fluid communication with the boiler and configured for adding a dilute aqueous hydrogen peroxide solution to the concentrated aqueous hydrogen peroxide solution within the boiler to maintain the concentration of the aqueous hydrogen peroxide solution in the boiler; wherein the manifold is further configured to deliver the dilute vapor to a critical process, application or storage vessel,
wherein at least one component selected from the group consisting of the boiler, the manifold, and a tube in fluid communication with boiler or manifold are formed from a material selected from the group consisting of stainless steel, quartz, nickel, aluminum, hastelloy, and monel, wherein any contact surface between the at least one component and the gas stream has previously undergone surface modification.

31. The chemical delivery system of claim 30, wherein the surface modification is a surface-coating selected from the group consisting of silicon, silicone, SiO₂, and combinations thereof.

32. The chemical delivery system of claim 30, wherein at least one component is heated to between 30° C. and about 300° C.

33. The chemical delivery system of claim 32, wherein at least one component is heated to between 80° C. and about 200° C.

34. The method of claim 30, wherein pressure within the at least one component is between 0.75 Torr and 1000 Torr.
